(19) United States
(12) Patent Application Publication
(10) Pub. No.: US 2003/0088491 A1
(43) Pub. Date: May 8, 2003

(54) Method and apparatus for identifying cross-selling opportunities based on profitability analysis

(75) Inventors: Shiping Liu, Castro Valley, CA (US); Jenny Yap, Singapore (SG)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 10/008,731

(22) Filed: Nov. 7, 2001

(51) Int. Cl. G06F 17/60

(52) U.S. Cl. 705/36

(57) ABSTRACT

A method and apparatus for identifying cross-selling opportunities based on profitability analysis in addition to association analysis are provided. With the apparatus and method, product holding and service information is extracted for each customer of an enterprise. The product or service profits are then calculated and categorized into profit levels. These profit levels are then embedded into the product/service information and is formatted for data mining. Data mining is then performed on the embedded and formatted data. The data mining results in an association analysis generating association rules. The association rules that result in a net profit for the enterprise as determined from the embedded profit levels, are identified. These association rules are then used to identify the customers to which cross-selling of the products/services in the association rule may be offered.

### BACKGROUND OF THE INVENTION

1. Technical Field

The present invention is directed to an improved data processing system and, in particular, an improved mechanism for determining cross-selling opportunities among products and/or services. More specifically, the present invention provides a mechanism through which cross-selling opportunities may be identified based on a profitability analysis.

2. Description of Related Art

Many organizations (such as banks, retail stores, insurance companies, and financial service organizations) collect and generate large volumes of data to guide them in their daily operations. Many have built data warehouses to provide access to the collectively “complete” data. However, in order to fully capitalize on data value, companies need to find and act on the hidden information in their data. This hidden information is not easy to discover.

In the last several years, many companies have turned to data mining to find this hidden information to help executives to make critical and smart business decisions. Banks and financial institutions are among the leading organizations that have used data mining as a tool to help them in making better decisions in their daily operations. One common application of data mining is to identify appropriate candidates and products for cross-selling.

Many financial institutions are already using data mining, specifically association analysis, to identify cross-sell candidates. Cross-selling, also referred to as up-selling or wallet share, is a key strategy for many companies. Cross-selling is important for many reasons. When customers have multiple relationships with a business such as a bank, they are far less likely to move their business to a competitor. Based on one retail bank's data, the attrition rate for customers who bought two products from the bank is about 55 percent. But the attrition rate drops to almost zero for those customers who have four or more products and services with the bank. Thus, cross-selling improves customer retention.

In addition, it is much more profitable to sell more products or services to an existing customer than to acquire a new customer. On average, credit card companies only start to make money in the third year of doing business with a customer. Also, cross-selling is consistent with the customer-centric service for which so many banks and other companies are striving.

Association analysis may be sufficient for retail stores but it is not sufficient for service companies such as banks. The business objective of a retail store is to get customers to buy as many products as possible, and the profitability level is attributed and can be controlled through the sales price of each unit in general. For a bank or other service company, however, not all products owned by each customer would produce profit for a bank due to operational costs and customer service related to each product. In fact, most banks do not make money from a large part of their customers for most products. Therefore, identifying products or services a customer may buy together may not be an optimum solution. Cross-selling a product or service to a customer who causes the bank to lose money from that sale does not improve the position of the bank.

Therefore, it would be beneficial to have an apparatus and method for identifying cross-selling opportunities based on a profitability analysis as well as a data mining association analysis. The present invention provides such an apparatus and method.

### SUMMARY OF THE INVENTION

The present invention provides a method and apparatus for identifying cross-selling opportunities based on profitability analysis in addition to association analysis. With the apparatus and method of the present invention, product holding and service information is extracted for each customer of an enterprise. The product or service profits are then calculated and categorized into profit levels. These profit levels are then embedded into the product/service information and is formatted for data mining.

Data mining is then performed on the embedded and formatted data. The data mining results in an association analysis generating association rules. The association rules that result in a net profit for the enterprise as determined from the embedded profit levels, are identified. These association rules are then used to identify the customers to which cross-selling of the products/services in the association rule may be offered.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of a distributed data processing system;

FIG. 2 is an exemplary block diagram of a server apparatus;

FIG. 3 is an exemplary block diagram of a client apparatus;

FIG. 4 is an exemplary block diagram of a cross-selling opportunity identification apparatus according to the present invention;

FIG. 5 is an exemplary diagram illustrating the effect of profitability analysis on association analysis according to the present invention; and

FIG. 6 is a flowchart outlining an exemplary operation of the present invention.

### DETAILED DESCRIPTION OF THE PREFERRED EMBODIMENT

The present invention provides a mechanism by which data compiled by a bank, financial institution, or other service-based enterprise, may be data mined and association analysis performed to identify potential cross-selling opportunities. These associations are also analyzed using profitability analysis to determine if such associations result in an increased profit for the enterprise. Based on this combined association and profitability analysis, cross-selling opportunities are identified for existing or potential customers.

As such, the present invention may be implemented in a computing environment that may comprise a stand alone computing device or a distributed data processing system in which a number of separate computing devices are utilized. In a preferred embodiment, the present invention is implemented in a distributed data processing environment such that the analysis may be performed in a separate location from the data warehouse. Therefore, a brief description of a distributed data processing environment in which the present invention may be implemented will now be provided.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

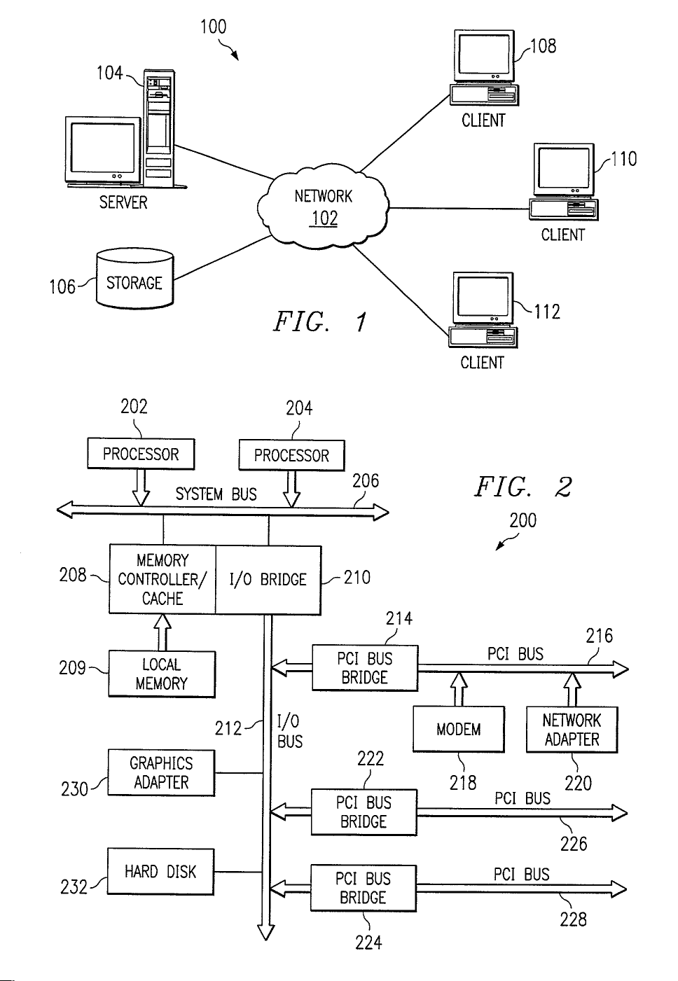

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

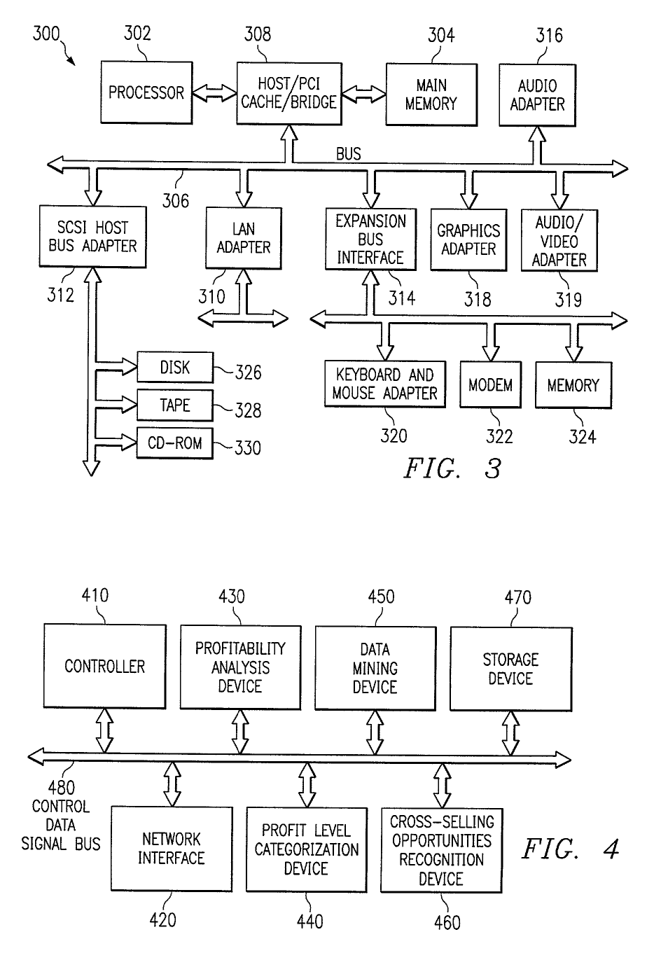

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the-art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides a mechanism through which data mining association analysis is improved by the inclusion of profitability analysis in determining cross-selling opportunities. The present invention may be implemented in a stand alone computing environment or a distributed data processing environment such as that shown in FIG. 1.

In a preferred embodiment, the present invention is utilized in a distributed data processing environment. In such an embodiment, the server 104 and on-line database 106 may be part of an enterprise computing system. With such an embodiment, the server 104 may be used to gather and store customer data in the on-line database 106. This customer data may then be used by the apparatus and method of the present invention by performing data mining and profitability analysis on the customer data to identify cross-selling opportunities. In addition, a user may make use of a client device, such as client device 108, to perform data mining and profitability analysis on the customer data in the on-line database 106.

While the present invention is especially suited for identifying cross-selling opportunities in financial products and/or services, the present invention is not limited to such. Rather, the present invention may be utilized with any business enterprise in which mere association analysis does not provide a sufficient identification of cross-selling opportunities.

To perform cross-selling effectively, it is first necessary to determine what to sell and who to sell to. There are two approaches to answer the question of what to cross-sell: business intuition and data mining analysis. Sometimes, business intuition can tell companies what to cross-sell. For example, home equity loans are a natural next sell to mortgage owners. Similarly, if a company develops a new and strategically important product, then that product or service may become a good product to cross-sell. In both examples, the question of what to cross-sell is clear to the company.

Using business intuition is a quick way to identify and promote potential products and services. The drawback in this approach is that the company may be missing opportunities by relying solely on business intuition. In some cases, products or services that would be a good cross-sell are missed because they aren't as obvious.

Data mining methods can also identify cross-selling opportunities. The following is an overview of the various aspects of data mining. One or more of these various aspects, such as association analysis, classification, clustering, etc., may be used with the present invention, as will be described in greater detail hereafter.

Background on Data Mining

Data mining is a process of extracting relationships in data stored in database systems. This is unlike users who query a database system for low-level information, such as an amount of money spent by a particular customer at a commercial establishment during the last month. Data mining systems, on the other hand, can build a set of high-level rules about a set of data, such as “If the customer is a white collar employee, and the age of the customer is over 30 years, and the amount of money spent by the customer on video games last year was above $100.00, then the probability that the customer will buy a video game in the next month is greater than 60%.” These rules allow an owner/operator of a commercial establishment to better understand the relationship between employment, age and prior spending habits and allows the owner/operator to make queries, such as “Where should I direct my direct mail advertisements?” This type of knowledge allows for targeted marketing and helps to guide other strategic decisions.

Other applications of data mining include finance, market data analysis, medical diagnosis, scientific tasks, VLSI design, analysis of manufacturing processes, etc. Data mining involves many aspects of computing, including, but not limited to, database theory, statistical analysis, artificial intelligence, and parallel/distributed computing.

Data mining may be categorized into several tasks, such as association, classification, and clustering.

There are also several knowledge discovery paradigms, such as rule induction, instance-based learning, neural networks, and genetic algorithms. Many combinations of data mining tasks and knowledge discovery paradigms are possible within a single application.

An association rule can be developed based on a set of data for which an attribute is determined to be either present or absent. For example, suppose data has been collected on a set of customers and the attributes are age and number of video games purchased last year. The goal is to discover any association rules between the age of the customer and the number of video games purchased.

Specifically, given two non-intersecting sets of items, e.g., sets X and Y, one may attempt to discover whether there is a rule “if X is 18 years old, then Y is 3 or more video games,” and the rule is assigned a measure of support and a measure of confidence that is equal to or greater than some selected minimum levels. The measure of support is the ratio of the number of records where X is 18 years old and Y is 3 or more video games, divided by the total number of records. The measure of confidence is the ratio of the number of records where X is 18 years old and Y is 3 or more video games, divided by the number of records where X is 18 years old. Due to the smaller number of records in the denominators of these ratios, the minimum acceptable confidence level is higher than the minimum acceptable support level.

Returning to video game purchases as an example, the minimum support level may be set at 0.3 and the minimum confidence level set at 0.8. An example rule in a set of video game purchase information that meets these criteria might be “if the customer is 18 years old, then the number of video games purchased last year is 3 or more.”

Given a set of data and a set of criteria, the process of determining associations is completely deterministic. Since there are a large number of subsets possible for a given set of data and a large amount of information to be processed, most research has focused on developing efficient algorithms to find all associations. However, this type of inquiry leads to the following question: Are all discovered associations really significant? Although some rules may be interesting, one finds that most rules may be uninteresting since there is no cause and effect relationship. For example, the association “if the customer is 18 years old, then the number of video games purchased last year is 3 or more” would also be a reported association with exactly the same support and confidence values as the association “if the number of video games purchase is 3 or more, then the age of the customer is 18 years old.”

Classification tries to discover rules that predict whether a record belongs to a particular class based on the values of certain attributes. In other words, given a set of attributes, one attribute is selected as the “goal,” and one desires to find a set of “predicting” attributes from the remaining attributes. One scenario could be a desire to know whether a particular customer will purchase a video game within the next month. A rather trivial example of this type of rule could include “If the customer is 18 years old, there is a 25% chance the customer will purchase a video game within the next month.”

A set of data is presented to the system based on past knowledge. This data “trains” the system. The present invention provides a mechanism by which such training data may be selected in order to better conform with actual customer behavior taking into account geographic influences. The goal is to produce rules that will predict behavior for a future class of data. The main task is to design effective algorithms that discover high quality knowledge. Unlike an association in which one may develop definitive measures for support and confidence, it is much more difficult to determine the quality of a discovered rule based on classification.

A problem with classification is that a rule may, in fact, be a good predictor of actual behavior but not a perfect predictor for every single instance. One way to overcome this problem is to cluster data before trying to discover classification rules. To understand clustering, consider a simple case where two attributes are considered: age and number of video games purchased last year. These data points can be plotted on a two-dimensional graph. Given this plot, clustering is an attempt to discover or “invent” new classes based on groupings of similar records. For example, for the above attributes, a clustering of data in the range of 17-20 years old for customer age might be found for 1-4 video games purchased last year. This cluster could then be treated as a single class.

Clusters of data represent subsets of data where members behave similarly but not necessarily the same as the entire population. In discovering clusters, all attributes are considered equally relevant. Assessing the quality of discovered clusters is often a subjective process. Clustering is often used for data exploration and data summarization.

Knowledge Discovery Paradigms

There are a variety of knowledge discovery paradigms, some guided by human users, e.g. rule induction and decision trees, and some based on AI techniques, e.g. neural networks. The choice of the most appropriate paradigm is often application dependent.

On-line analytical processing (OLAP) is a database-oriented paradigm that uses a multidimensional database where each of the dimensions is an independent factor, e.g., customer vs. video games purchased vs. income level. There are a variety of operators provided that are most easily understood if one assumes a three-dimensional space in which each factor is a dimension of a vector within a three-dimensional cube. One may use “pivoting” to rotate the cube to see any desired pair of dimensions. “Slicing” involves a subset of the cube by fixing the value of one dimension. “Roll-up” employs higher levels of abstraction, e.g., moving from video games bought-by-age to video games bought-by-income level, and “drill-down” goes to lower levels, e.g., moving from video games bought-by-age to video games bought-by-gender.

The Data Cube operation computes the power set of the “Group by” operation provided by SQL. For example, given a three dimension cube with dimensions A, B, C, then Data Cube computes Group by A, Group by B, Group by C, Group by A,B, Group by A,C, Group by B,C, and Group by A,B,C. OLAP is used by human operators to discover previously undetected knowledge in the database.

Recall that classification rules involve predicting attributes and the goal attribute. Induction on classification rules involves specialization, i.e. adding a condition to the rule antecedent, and generalization, i.e. removing a condition from the antecedent. Hence, induction involves selecting what predicting attributes will be used. A decision tree is built by selecting the predicting attributes in a particular order, e.g., customer age, video games purchased last year, income level.

The decision tree is built top-down assuming all records are present at the root and are classified by each attribute value going down the tree until the value of the goal attribute is determined. The tree is only as deep as necessary to reach the goal attribute. For example, if no customers of age 2 bought video games last year, then the value of the goal attribute “number of video games purchase last year?” would be determined (value equals “0”) once the age of the customer is known to be 2. However, if the age of the customer is 7, it may be necessary to look at other predicting attributes to determine the value of the goal attribute. A human is often involved in selecting the order of attributes to build a decision tree based on “intuitive” knowledge of which attribute is more significant than other attributes.

Decision trees can become quite large and often require pruning, i.e. cutting off lower level subtrees or branches. Pruning avoids “overfitting” the tree to the data and simplifies the discovered knowledge. However, pruning too aggressively can result in “underfitting” the tree to the data and missing some significant attributes.

The above techniques provide tools for a human to manipulate data until some significant knowledge is discovered and removes some of the human expert knowledge interference from the classification of values. Other techniques rely less on human intervention. Instance-based learning involves predicting the value of a tuple, e.g., predicting if someone of a particular age and gender will buy a product, based on stored data for known tuple values. A distance metric is used to determine the values of the N closest neighbors, and these known values are used to predict the unknown value. The final technique examined is neural nets. A typical neural net includes an input layer of neurons corresponding to the predicting attributes, a hidden layer of neurons, and an output layer of neurons that are the result of the classification. For example, there may be eight input neurons corresponding to “under 3 video games purchase last year”, “between 3 and 6 video games purchase last year”, “over 6 video games purchased last year”, “in Plano, Tex.”, “customer age below 10 years old”, “customer age above 18 years old”, and “customer age between 10 and 18 years old.” There could be two output neurons: “will purchase video game within next month” and “will not purchase video game within next month”. A reasonable number of neurons in the middle layer are determined by experimenting with a particular known data set.

There are interconnections between the neurons at adjacent layers that have numeric weights. When the network is trained, meaning that both the input and output values are known, these weights are adjusted to give the best performance for the training data. The “knowledge” is very low level (the weight values) and is distributed across the network. This means that neural nets do not provide any comprehensible explanation for their classification behavior—they simply provide a predicted result.

Neural nets may take a very long time to train, even when the data is deterministic. For example, to train a neural net to recognize an exclusive-or relationship between two Boolean variables may take hundreds or thousands of training data (the four possible combinations of inputs and corresponding outputs repeated again and again) before the neural net learns the circuit correctly. However, once a neural net is trained, it is very robust and resilient to noise in the data. Neural nets have proved most useful for pattern recognition tasks, such as recognizing handwritten digits in a zip code.

Other knowledge discovery paradigms can be used, such as genetic algorithms. However, the above discussion presents the general issues in knowledge discovery. Some techniques are heavily dependent on human guidance while others are more autonomous. The selection of the best approach to knowledge discovery is heavily dependent on the particular application.

Data Warehousing

The above discussions focused on data mining tasks and knowledge discovery paradigms. There are other components to the overall knowledge discovery process.

Data warehousing is the first component of a knowledge discovery system and is the storage of raw data itself. One of the most common techniques for data warehousing is a relational database. However, other techniques are possible, such as hierarchical databases or multidimensional databases. No matter which type of database is used, it should be able to store points, lines, and polygons such that geographic distributions can be assessed. This type of warehouse or database is sometimes referred to as a spatial data warehouse.

Data is nonvolatile, i.e. read-only, and often includes historical data. The data in the warehouse needs to be “clean” and “integrated”. Data is often taken from a wide variety of sources. To be cleaned and integrated means data is represented in a consistent, uniform fashion inside the warehouse despite differences in reporting the raw data from various sources.

There also has to be data summarization in the form of a high level aggregation. For example, consider a phone number 111-222-3333 where 111 is the area code, 222 is the exchange, and 3333 is the phone number. The telephone company may want to determine if the inbound number of calls is a good predictor of the outbound number of calls. It turns out that the correlation between inbound and outbound calls increases with the level of aggregation. In other words, at the phone number level, the correlation is weak but as the level of aggregation increases to the area code level, the correlation becomes much higher.

Data Pre-Processing

After the data is read from the warehouse, it is pre-processed before being sent to the data mining system. The two pre-processing steps discussed below are attribute selection and attribute discretization.

Selecting attributes for data mining is important since a database may contain many irrelevant attributes for the purpose of data mining, and the time spent in data mining can be reduced if irrelevant attributes are removed beforehand. Of course, there is always the danger that if an attribute is labeled as irrelevant and removed, then some truly interesting knowledge involving that attribute will not be discovered.

If there are N attributes to choose between, then there are 2^{N} possible subsets of relevant attributes. Selecting the best subset is a nontrivial task. There are two common techniques for attribute selection. The filter approach is fairly simple and independent of the data mining technique being used. For each of the possible predicting attributes, a table is made with the predicting attribute values as rows, the goal attribute values as columns, and the entries in the table as the number of tuples satisfying the pairs of values. If the table is fairly uniform or symmetric, then the predicting attribute is probably irrelevant. However, if the values are asymmetric, then the predicting attribute may be significant.

The second technique for attribute selection is called a wrapper approach where attribute selection is optimized for a particular data mining algorithm. The simplest wrapper approach is Forward Sequential Selection. Each of the possible attributes is sent individually to the data mining algorithm and its accuracy rate is measured. The attribute with the highest accuracy rate is selected. Suppose attribute 3 is selected; attribute 3 is then combined in pairs with all remaining attributes, i.e., 3 and 1, 3 and 2, 3 and 4, etc., and the best performing pair of attributes is selected.

This hill climbing process continues until the inclusion of a new attribute decreases the accuracy rate. This technique is relatively simple to implement, but it does not handle interaction among attributes well. An alternative approach is backward sequential selection that handles interactions better, but it is computationally much more expensive.

Discretization involves grouping data into categories. For example, age in years might be used to group persons into categories such as minors (below 18), young adults (18 to 39), middle-agers (40-59), and senior citizens (60 or above). Some advantages of discretization are time reduction in data mining and improvement in the comprehensibility of the discovered knowledge. Categorization may actually be required by some mining techniques. A disadvantage of discretization is that details of the knowledge may be suppressed.

Blindly applying equal-weight discretization, such as grouping ages by 10 year cycles, may not produce very good results. It is better to find “class-driven” intervals. In other words, one looks for intervals that have uniformity within the interval and have differences between the different intervals.

Data Post-Processing

The number of rules discovered by data mining may be overwhelming, and it may be necessary to reduce this number and select the most important ones to obtain any significant results. One approach is subjective or user-driven. This approach depends on a human's general impression of the application domain. For example, the human user may propose a rule such as “if a customer's age is less than 18, then the customer has a higher likelihood of purchasing a video game.” The discovered rules are then compared against this general impression to determine the most interesting rules. Often, interesting rules do not agree with general expectations. For example, although the conditions are satisfied, the conclusion is different than the general expectations. Another example is that the conclusion is correct, but there are different or unexpected conditions.

Rule affinity is a more mathematical approach to examining rules that does not depend on human impressions. The affinity between two rules in a set of rules {Rᵢ} is measured and given a numerical affinity value between zero and one, called Af(Rₓ,R_{y}). The affinity value of a rule with itself is always one, while the affinity with a different rule is less than one. Assume that one has a quality measure for each rule in a set of rules {Rᵢ}, called Q(Rᵢ). A rule Rⱼ is said to be suppressed by a rule Rₖ if Q(Rⱼ)<Af(Rⱼ,Rₖ)*Q(Rₖ). Notice that a rule can never be suppressed by a lower quality rule since one assumes that Af(Rⱼ,Rₖ)<1 if j ¹ k. One common measure for the affinity function is the size of the intersection between the tuple sets covered by the two rules, i.e. the larger the intersection, the greater the affinity.

Data Mining Summary

The discussion above has touched on the following aspects of knowledge processing: data warehousing, pre-processing data, data mining itself, and post-processing to obtain the most interesting and significant knowledge. With large databases, these tasks can be very computationally intensive, and efficiency becomes a major issue. Much of the research in this area focuses on the use of parallel processing. Issues involved in parallelization include how to partition the data, whether to parallelize on data or on control, how to minimize communications overhead, how to balance the load between various processors, how to automate the parallelization, how to take advantage of a parallel database system itself, etc.

Many knowledge evaluation techniques involve statistical methods or artificial intelligence or both. The quality of the knowledge discovered is highly application dependent and inherently subjective. A good knowledge discovery process should be both effective, i.e. discovers high quality knowledge, and efficient, i.e. runs quickly.

Cross-Selling Analysis

With the present invention, the various aspects of knowledge processing, which include data mining, are used in conjunction with profitability analysis to identify cross-selling opportunities. In particular, association analysis is used to effectively identify products or services that can be promoted and cross-sold to customers. In most cases, the cross-sell opportunities identified through business intuition could also be identified through this association analysis approach. However, association analysis alone does not identify those opportunities. The enterprise's business strategy and intuitions may lead to certain products being selected for marketing and other campaigns. Therefore, it is optimal to combine analytical results with business intuition.

Once potential cross-selling products or services have been identified, the next question is who to cross sell to. There are several ways to answer this question. One is to use association rules to identify those potential customers who have “appeared” in the rules, but have not bought the targeted products or service. Association rules indicate the relationship among the products. In general, association rules have a rule body, rule head, support, confidence, and lift. The following is an example of an association rule in the context of the present invention:

Visa Gold =>house loan with support of 0.85, 28.5 as confidence, and 10.7 as lift.

This rule means that when a customer has a Visa Gold; then the customer is also likely to have a housing loan in 28.5 percent of cases, which is 10.7 times more likely than in the overall population. Among all people, 0.85 percent have both a Visa Gold and a house loan. (more about association rules may be obtained from the Data Miner column of the Quarter 1, 2000: Spring issue of DB2 Magazine, available online at http://www.db2mag.com/db_area/archives/2000/q1/miner.shtml.)

The second approach is to build a classification model to predict who is likely to purchase identified products or services. The third is to build a classification model to predict the likelihood of buying a product based on those customers that have been identified from association rules only. The choice of which method to adopt depends on the companies objective and data availability.

In general, if data such as customers' product holding information, demographic variables and financial behavior variables are available, association analysis is the best place to start in order to identify what to cross-sell as compared to the second and third approach. Association analysis will derive a list of possible rules (potential cross-sell opportunities) while the latter approaches would need to have the products to be identified first. Potential products or services identified by business intuition can be validated and added to the cross sell products and services pools if necessary.

By performing association analysis, both questions, i.e. what to cross-sell and who to cross-sell to, would have been answered. In other words, association analysis will identify both the potential products and services that customer would be likely to purchase together and which customers were identified by rules but have not purchased products yet (the cross-selling potential pool). Classification models can be used to enhance the precision of prediction by predicting the probability of customers acquiring or responding to the marketing campaigns.

Association analysis with or without classification models may be sufficient for retail stores but it is not sufficient for service companies such as banks and other financial institutions. The business objective of a retail store is to get customers to buy as many products as possible. The profitability level is attributed to, and can be controlled through, the sales price of each unit in general. For a bank, however, not all products owned by each customer produce profit for a bank due to operational cost and customer service related to each product. In fact, most banks do not make money from a large portion of their customers for most products.

Therefore, identifying products or services a customer may buy together, such as through data mining association analysis, may not, by itself, identify the most profitable combination of goods/services for cross-selling opportunities. Cross-selling a product or service to a customer who causes the bank to lose money from that sale does not make sound business sense.

To avoid this outcome, the present invention incorporates profitability analysis into association analysis for cross selling opportunity identification. By doing so, not only are the questions of what products or services may be cross-sold and who these products and services may be cross-sold to are answered, but also the question of whether doing the cross-selling will be profitable to the enterprise is answered.

Any company in any industry that sells multiple products and services to consumers can benefit from embedding profitability analysis results into association analysis. The combination of profitability analysis with association analysis offers the potential to improve customer relationships, reduce customer attrition rates, and increase company profitability.

It has been described above how association analysis can identify cross-selling opportunities. Rules generated from association analysis identify those products that customers would likely purchase together or services that customers would like to have. But it does not distinguish low or negative profitability. The methods most companies currently use cannot distinguish between profitable and unprofitable products because most companies do not know how to incorporate profit level into association analysis.

The present invention uses a five-step method for embedding profitability analysis results into association analysis. First, the profitability for each major or strategically important product or service is calculated. Focusing on major or strategic products is very important. Most banks offer many products and services, and the information needed to calculate profitability may not be available for each one. In addition, it may be unnecessary or even undesirable to calculate profits for every product (for example, those that are used by a very small number of customers).

After calculating profits for the more important products, the second step is to categorize profit levels based on the enterprise's business situation. Each product is to be assigned a new product code by concatenating the current product code to a profit category level or by concatenating a new number to a profit category level. Step three involves performing association analysis to identify cross-selling opportunities based on existing customers' behavior.

In step four, those rules identified by association analysis that have a qualifying (i.e. good or interesting) support, confidence, or lift are examined. That is, rules leading to highly profitable products or services would be considered as opportunities for cross-selling. But rules leading to low or negative profitability also reveal useful information. Customers who are identified as leading to low profitability can be dropped from the next marketing campaign or promotion. After the rules are determined and analyzed, customers belonging to these rules can be profiled and analyzed.

The last step is to extract the relevant and necessary information to enable the enterprise to target potential customers for cross-selling, and at the same time, to know which type of customers the enterprise should avoid for promotions. Questions such as what do they look like, and what are their typical behaviors can be answered by examining their demographic profiles. By knowing who they are and what they do, more effective methods of communication can be worked out through these identified customers' characteristics.

The following is an example of a profit embedded association rule:

Visa Gold with high profitability ==>house loan with high profitability with support of 0.22, 10.7 as confidence, and 13.3 as lift.

This rule means that when a customer has a Visa Gold (high profitability); then the customer is also likely to have a housing loan (high profitability) in 10.7 percent of cases, which is 13.3 times more likely than in the overall population. The support stated in this rule is much smaller than the one identified in the previous rule. The cross-selling opportunities are only a subset of the opportunities identified in the previous rule because customers with high profit potential are only identified. This identification is based on the profit category level.

When profitability is embedded into association analysis, the results of association rules indicate not just which product or combination of products lead to a specific product, but also which products are profitable and which are not. This type of information can reveal which group of customers should be good targets for cross-selling and which customers should be avoided.

FIG. 4 is an exemplary block diagram of a cross-selling opportunity identification apparatus according to the present invention. The elements shown in FIG. 4 may be implemented in hardware, software, or any combination of hardware and software. In addition, the elements shown in FIG. 4 may be part of a single computing device, such as a client device or a server, or may be distributed across a plurality of devices in a distributed data processing system. In a preferred embodiment of the present invention, the elements shown in FIG. 4 are implemented as software instructions executed by one or more processors in a computing device.

As shown in FIG. 4, the cross-selling opportunity identification apparatus includes a controller 410, a network interface 420, a profitability analysis device 430, a profit level categorization device 440, a data mining device 450, cross-selling opportunities recognition device 460, and storage device 470. The elements 410-470 are coupled to one another via the control/data signal bus 480. Although a bus architecture is shown in FIG. 4, the present invention is not limited to such and any architecture that facilitates the communication of control and data signals between the elements 410-470 may be used without departing from the spirit and scope of the present invention.

The controller 410 controls the overall operation of the cross-selling opportunities identification apparatus and orchestrates the operation of the other elements 420-470. The controller 410 receives requests for cross-selling opportunities identification via the network interface 420. In response, the controller 410 initiates retrieval of product holding and service information for each customer of an enterprise from the enterprise's customer information database. This customer information may be temporarily stored in the storage device 470. The controller 410 then instructs the profitability analysis device 430 to operate on the retrieved customer information.

The profitability analysis device 430 analyses the customer information and identifies the profitability of the most important products/services to the enterprise. These profitability's are then categorized into levels, such as high, medium and low. The profitability levels are then associated with the products/services and the product/services embedded with the profitability levels are then stored. Data mining is then performed on the customer information by the data mining device 450 to identify association rules.

The resulting association rules are analyzed by the cross-selling opportunities recognition device 460 which identifies a subset of the association rules that indicate an acceptable level of profitability. This subset of association rules is then used as a way of directing business efforts towards cross-selling products and/or services to customers. For example, the subset of association rules may be used to identify the number of customers that can be cross-sold and then to design communication channels and communication messages for cross-selling to these customers.

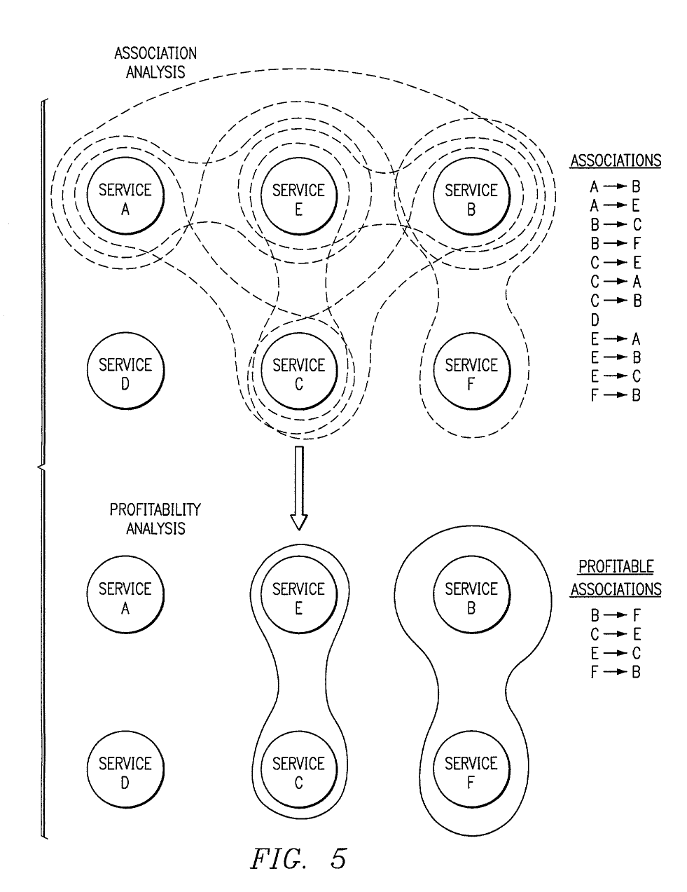

FIG. 5 is an exemplary diagram that illustrates the benefits of profitability analysis in addition to association analysis in accordance with the present invention. As shown in FIG. 5, using only association analysis, there may be many associations identified (represented as dotted lines around the services) as possibilities for cross-selling to customers. However, not all of these associations result in a profit for the enterprise, as discussed in detail previously.

By applying profitability analysis, the number of associations identified is appreciably reduced to only those that provide an acceptable level of profitability (shown as solid lines around the services). By reducing the number of associations down to only those that are profitable to the enterprise, resources are not wasted on pursuing cross-selling opportunities that do not result in a profit to the enterprise.

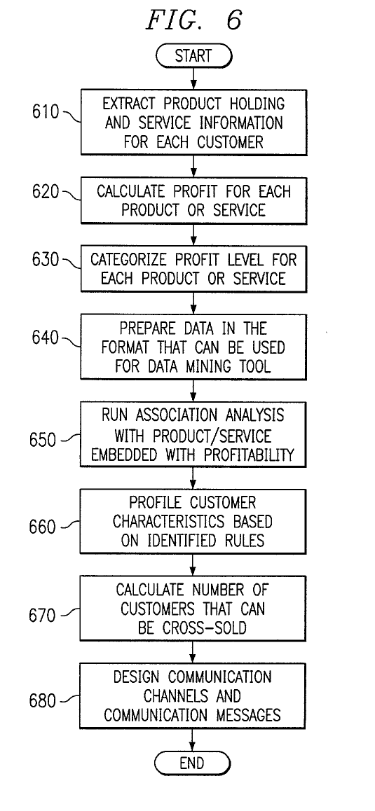

FIG. 6 is a flowchart outlining an exemplary operation of the present invention. As shown in FIG. 6, the operation starts with extraction of product holding and service information for each customer of the enterprise (step 610). The profit for each product or service is then calculated (step 620). Rather than calculating the profit for each product or service, only the most important products and services may be involved in the profit calculation.

The each product or service is then categorized into profit levels (step 630). The data is then formatted for use by a data mining tool (step 640) and the data is then mined by performing association analysis on the formatted data (step 650). Additional data mining tasks may be performed on the data in addition to the association analysis, depending on the particular implementation. Thereafter, the customer characteristics for the association rules resulting in an acceptable profit level are determined (step 660).

Based on these customer characteristics, the number of customers that can be cross-sold is calculated (step 670). Communication channels and communication messages are then designed in order to solicit cross-selling to the identified customers (step 680).

Thus, the present invention provides an apparatus and method for identifying cross-selling opportunities based on profitability analysis. The present invention overcomes the drawbacks of the prior art by providing additional analysis for identifying only those product/service associations that result in a profit for the enterprise. In this way, valuable resources are not wasted on promoting cross-selling of non-profitable product/service couplings.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a computing device, for identifying cross-selling opportunities, comprising:
processing data to identify associations of products or services for potential cross-selling; and
processing the identified associations to identify a subset of the associations based on profitability analysis such that the subset of associations determined, from the profitability analysis, to generate a profit when cross-sold.

2. The method of claim 1, wherein processing data to identify associations of products or services for potential cross-selling includes generating one or more association rules using one or more knowledge processing techniques.

3. The method of claim 2, wherein the one or more processing techniques include association analysis.

4. The method of claim 1, further comprising:
calculating profitability for at least two of the products or services.

5. The method of claim 4, further comprising:
identifying profit level categories based on business logic; and
associating the at least two products or services with one or more of the profit level categories.

6. The method of claim 5, wherein the subset of associations are associations which have products or services that are associated with profitable profit level categories.

7. The method of claim 5, wherein the subset of associations are associations which have products or services that are associated with profit level categories that meet acceptable criteria.

8. The method of claim 1, further comprising:
identifying one or more customers for marketing cross-selling opportunities based on the subset of associations.

9. The method of claim 1, further comprising:
generating one or more marketing strategies based on the subset of associations.

10. The method of claim 1, wherein the association rules include a correspondence between two or more products or services, a measure of profitability, a measure of support, a measure of confidence, and a measure of lift.

11. An apparatus for identifying cross-selling opportunities, comprising:
means for processing data to identify associations of products or services for potential cross-selling; and
means for processing the identified associations to identify a subset of the associations based on profitability analysis such that the subset of associations determined, from the profitability analysis, to generate a profit when cross-sold.

12. The apparatus of claim 11, wherein the means for processing data to identify associations of products or services for potential cross-selling includes means for generating one or more association rules using one or more knowledge processing techniques.

13. The apparatus of claim 12, wherein the one or more processing techniques include association analysis.

14. The apparatus of claim 11, further comprising:
means for calculating profitability for at least two of the products or services.

15. The apparatus of claim 14, further comprising:
means for identifying profit level categories based on business logic; and
means for associating the at least two products or services with one or more of the profit level categories.

16. The apparatus of claim 15, wherein the subset of associations are associations which have products or services that are associated with profitable profit level categories.

17. The apparatus of claim 15, wherein the subset of associations are associations which have products or services that are associated with profit level categories that meet acceptable criteria.

18. The apparatus of claim 11, further comprising:
means for identifying one or more customers for marketing cross-selling opportunities based on the subset of associations.

19. The apparatus of claim 11, further comprising:
means for generating one or more marketing strategies based on the subset of associations.

20. The apparatus of claim 11, wherein the association rules include a correspondence between two or more products or services, a measure of profitability, a measure of support, a measure of confidence, and a measure of lift.

21. A computer program product in a computer readable medium for identifying cross-selling opportunities, comprising:
first instructions for processing data to identify associations of products or services for potential cross-selling; and
second instructions for processing the identified associations to identify a subset of the associations based on profitability analysis such that the subset of associations determined, from the profitability analysis, to generate a profit when cross-sold.

22. The computer program product of claim 21, wherein the first instructions for processing data to identify associations of products or services for potential cross-selling include instructions for generating one or more association rules using one or more knowledge processing techniques.

23. The computer program product of claim 22, wherein the one or more processing techniques include association analysis.

24. The computer program product of claim 21, further comprising:
third instructions for calculating profitability for at least two of the products or services.

25. The computer program product of claim 24, further comprising:
fourth instructions for identifying profit level categories based on business logic; and
fifth instructions for associating the at least two products or services with one or more of the profit level categories.

26. The computer program product of claim 25, wherein the subset of associations are associations which have products or services that are associated with profitable profit level categories.

27. The computer program product of claim 25, wherein the subset of associations are associations which have products or services that are associated with profit level categories that meet acceptable criteria.

28. The computer program product of claim 21, further comprising:
third instructions for identifying one or more customers for marketing cross-selling opportunities based on the subset of associations.

29. The computer program product of claim 21, further comprising:
third instructions for generating one or more marketing strategies based on the subset of associations.

30. The computer program product of claim 21, wherein the association rules include a correspondence between two or more products or services, a measure of profitability, a measure of support, a measure of confidence, and a measure of lift.
